(19) United States
(12) Patent Application Publication
(10) Pub. No.: US 2014/0325468 A1
(43) Pub. Date: Oct. 30, 2014

(54) STORAGE MEDIUM, AND GENERATION APPARATUS FOR GENERATING TRANSACTIONS FOR PERFORMANCE EVALUATION

(71) Applicant: FUJITSU SEMICONDUCTOR LIMITED, Yokohama-shi (JP)

(72) Inventors: NOBUYUKI SATOH, Akiruno (JP); Masahiro KATO, Tachikawa (JP); KUNIAKI JIN, Akiruno (JP); Yuuki Watanabe, Akiruno (JP); Seiya Fukushima, Kawasaki (JP)

(73) Assignee: FUJITSU SEMICONDUCTOR LIMITED, Yokohama-shi (JP)

(21) Appl. No.: 14/252,060

(22) Filed: Apr. 14, 2014

(30) Foreign Application Priority Data
Apr. 24, 2013 (JP) 2013-091661

(51) Int. Cl. G06F 17/50

(52) U.S. Cl. CPC G06F 17/5045
USPC 716/136

(57) ABSTRACT

A non-transitory computer-readable recording medium having stored therein a program for causing a computer to execute a process comprising: generating a transaction scenario that describes a dependency between operations of semiconductor elements included in a semiconductor circuit, according to a parameter for defining the dependency and waveform data that indicates a level transition of each signal output from each of the semiconductor elements; and generating transactions for testing the semiconductor circuit, according to the transaction scenario.

### CROSS-REFERENCE TO RELATED APPLICATION

This application is based upon and claims the benefit of priority of the prior Japanese Patent Application No. 2013-091661, filed on Apr. 24, 2013, the entire contents of which are incorporated herein by reference.

### FIELD

The embodiments discussed herein are related to a technique for generating transactions for evaluating performance of a hardware system including logic circuits.

### BACKGROUND

With the advance of processing techniques, the densities of Large Scale Integrated Circuits (hereinafter abbreviated to LSIs) have been increasing, so that a system LSI can be mounted on a single chip. Also function modules mounted on a chip have been diversified, leading to an increase in a circuitry scale.

In recent years, implementations of more complex architectures have been demanded in many cases so as to satisfy performance requirements. Accordingly, a problem caused by an architecture is more prone to occur. An architecture is a basic configuration of hardware of an LSI, and is, for example, a configuration realized by combining a plurality of function blocks included in the LSI.

To evaluate a throughput of the entire system of an LSI, it is desirable to test the system by operating hardware and software simultaneously. For example, when the system is tested by using an RTL (Register Transfer Level) for a circuit description, the entire system is simulated at a level of a specific hardware configuration.

For a simulation method of a system architecture, a technique for keeping logging of data transmissions and receptions between function blocks, and for performing a simulation according grouping is proposed.

FIG. 1 is an explanatory diagram of a problem in conventional LSI development.

The LSI development is made as illustrated in FIG. 1. Namely, for hardware, a “hardware design” is made for the hardware based on a given “specification design”, a “hardware test” is conducted, and “LSI manufacturing” is made thereafter. In contrast, for software, a “software design” is made, and a “software test” is conducted thereafter.

A conventional system evaluation is made thereafter. Namely, a system evaluation is made only after a hardware design is complete. Even if a problem caused by an architecture occurs in a system evaluation, performing a large-scale feedback is not very feasible. This is because many operations need to be redone.

Accordingly, a mechanism that satisfies the following conditions (1) and (2) is desirable.
(1) A system evaluation enable to be made at an early stage of development where a feedback to an architecture is feasible (specifically, before a hardware design is complete).
(2) A system evaluation that enables a problem caused by an architecture to be found can be made.

As a mechanism that satisfies the above described condition (1), a performance evaluation technique using an ESL (Electronics System Level) model is proposed. ESL is software that virtually represents hardware. Moreover, an ESL model description language (specifically, a language named “SystemC”) and an ESL simulator, which implement a performance evaluation using an ESL model, have been already realized.

FIG. 2 illustrates a system evaluation environment using the ESL technique.

As illustrated in FIG. 2, the ESL simulator represents various pieces of hardware by virtually modeling them with software. Examples of the various pieces of hardware include a CPU (Central Processing Unit), a MEM (memory), a DMAC (Direct Memory Access Controller), and the like. The ESL simulator is a simulator for simulating a “transaction”, which is an instruction for a simulation target, at an electronic system level.

Also a technique for defining transaction procedures for describing specifications of hardware, and for automatically generating a test device of a sequential machine based on a transaction identifier is proposed.

For the mechanism that satisfies the above described condition (2), it is important to make a performance evaluation based on a system operation (namely, a system operation in an actual use case) according to an actual use in order to find a problem caused by an architecture. An environment for representing the following elements is desirable to implement such a performance evaluation.

Environment where a transaction load of each hardware macro (hereinafter referred to simply as a “macro”) is represented when a system operates in an actual use

Environment where the transaction load is represented with high accuracy (a transaction of macro specifications is represented)

As is proved from the above provided description, a mechanism for faithfully reproducing transactions of a macro with ESL models is desirable.

Additionally, cases rarely happen where all macros are newly developed in the current LSI development. In most cases, newly developed IPs (Intellectual Properties) and exiting IPs are combined. Accordingly, as targets to be modeled with ESL, a use case of a newly developed IP (namely, an IP without RTL) and a use case of an existing IP (namely, IP with RTL) are present.

FIG. 3 illustrates a relationship between the use cases and the conventional techniques.

As illustrated in FIG. 3, two methods such as “handmade” and “waveform reproduction” are conventionally used depending on a use case as a mechanism for faithfully reproducing transactions of a macro with ESL models.

Such conventional techniques had a problem such that a considerable amount of time is needed to develop models with which transactions are faithfully reproduced.

FIG. 4 is an explanatory diagram of the “handmade” method.

As illustrated in FIG. 4, modeling 42 is initially performed based on macro specifications 41 with the “handmade” method. With the modeling 42, a user creates ESL models 43 that faithfully simulate transactions of a macro.

With this “handmade” method, transactions of a macro can be faithfully reproduced by creating the ESL models 43. In the meantime, development of the ESL models 43 having high accuracy involves a study of complex implementation specifications. Accordingly, the “handmade” method needs time and cost, so that this method sometimes fails to prepare models in a desired time period.

FIG. 5 is an explanatory diagram of a traffic generator offered by Synopsys, Inc.

For example, a traffic generator included in a system level test tool “PlatformArchitect MCO (Multicore Optimization Technology)” offered by Synopsys, Inc. is described. The traffic generator receives waveform information of a hardware macro as an input. The waveform information is also called VCD (Value Change Dump), and indicates execution results of hardware. The traffic generator extracts only a request (also referred to as a request transaction) from the waveform information, and simulates only the request transaction. By imposing a load on a bus model with the use of the request transaction, an architecture is evaluated.

With the waveform reproduction method for solving the problem posed by the “handmade” method, the mechanism for simulating only a request transaction by using waveform information of a macro is realized when RTL for a modeling target is present. This is proved, for instance, from the example of the traffic generator offered by Synopsys, Inc. illustrated in FIG. 5.

With the “waveform reproduction method”, transactions are reproduced from waveform information, eliminating the need for a user to develop models. Accordingly, with the “waveform reproduction method”, modeling of transactions of a macro can be performed with ease and in a short time.

For example, some documents such as Japanese Laid-open Patent Publication No. 2003-67439, Japanese Laid-open Patent Publication No. 2004-21730, and the like are known.

### SUMMARY

According to an aspect of the embodiments, a non-transitory computer-readable recording medium having stored therein a program for causing a computer to execute a process comprising: generating a transaction scenario that describes a dependency between operations of semiconductor elements included in a semiconductor circuit, according to a parameter for defining the dependency and waveform data that indicates a level transition of each signal output from each of the semiconductor elements; and generating transactions for testing the semiconductor circuit, according to the transaction scenario.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram of a problem in a conventional LSI development.

FIG. 2 illustrates a system evaluation environment using an ESL technique.

FIG. 3 illustrates a relationship between use cases and conventional techniques.

FIG. 4 is an explanatory diagram of a “handmade method”.

FIG. 5 is an explanatory diagram of a traffic generator offered by Synopsys, Inc.

FIGS. 6A and 6B are explanatory diagrams of a problem to be solved in one aspect of the embodiments.

FIG. 7 illustrates a hardware system (specifically, a personal computer) of a transaction generating apparatus in which a transaction generating program for generating transactions for a performance evaluation is executed.

FIG. 8 illustrates a structure of the transaction generating apparatus.

FIG. 9 illustrates an example of a waveform file.

FIG. 10 illustrates an example of a parameter file.

FIG. 11 illustrates an example of a transaction scenario file.

FIG. 12 illustrates a structure of a transaction scenario generating device.

FIG. 13 is a flowchart illustrating a flow of a transaction scenario generating process executed by the transaction scenario generating device.

FIGS. 14A and 14B are explanatory diagrams of a process for extracting transactions from a waveform.

FIG. 15 is an explanatory diagram of a process for putting a dependency within the same channel.

FIG. 16 is an explanatory diagram of a process for putting a dependency between different channels.

FIGS. 17A and 17B are explanatory diagrams of generation of a transaction scenario.

FIG. 18 is an explanatory diagram of how a transaction executing program, with which a transaction executing device executes a transaction executing process, works.

FIG. 19 is a flowchart illustrating a flow of the transaction executing process executed by the transaction executing device.

FIG. 20 illustrates an example of the transaction executing program.

FIGS. 21A to 21C illustrate a flow of an operation (specifically, a flow of a read operation) of the transaction executing device that executes the transaction executing process.

FIGS. 22A to 22C illustrate a flow of an operation (specifically, a flow of a write operation) of the transaction executing device that executes the transaction executing process.

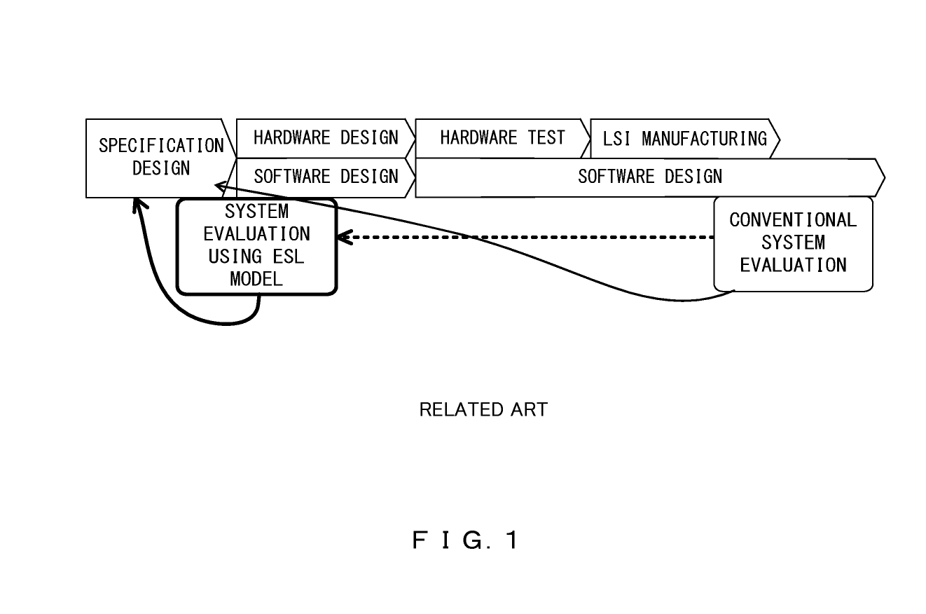

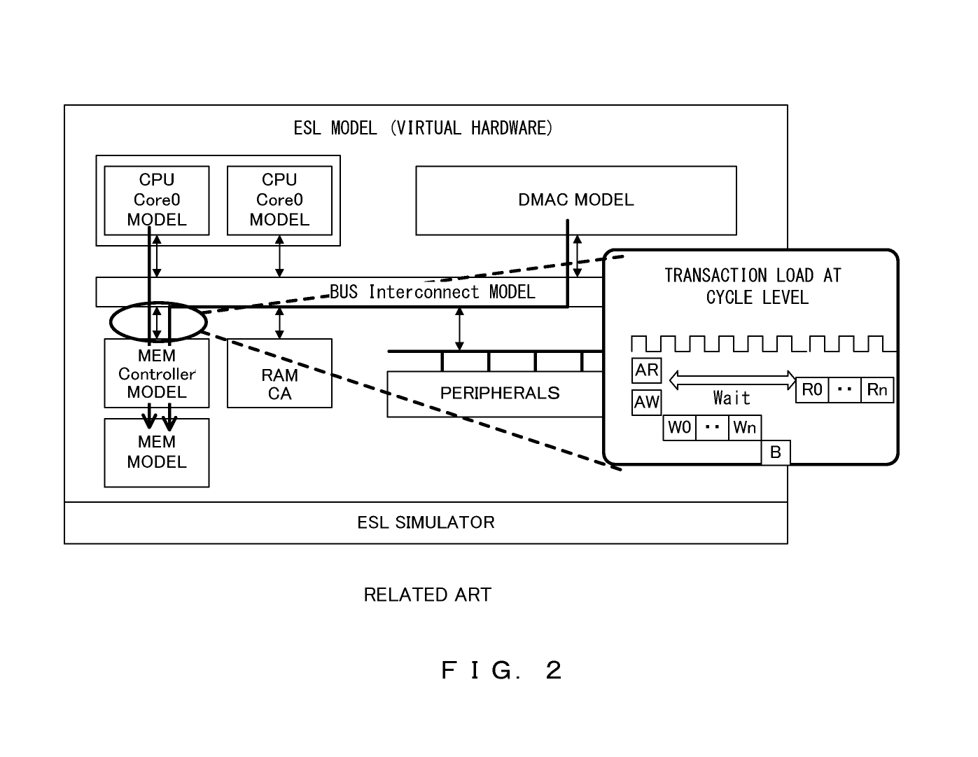

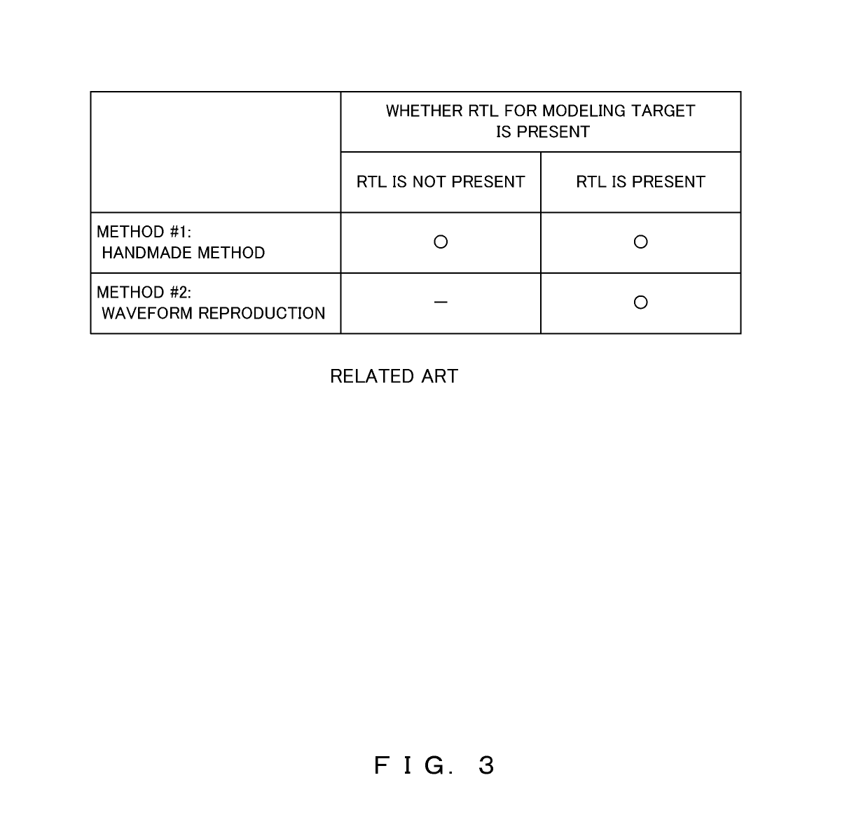

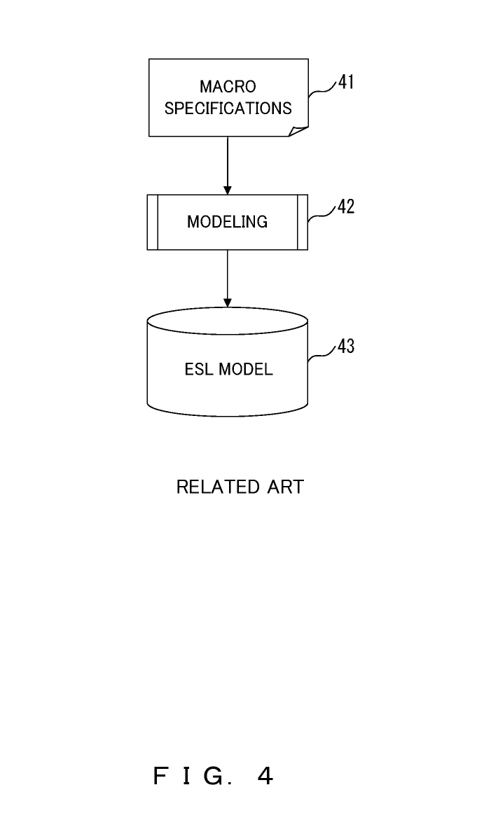

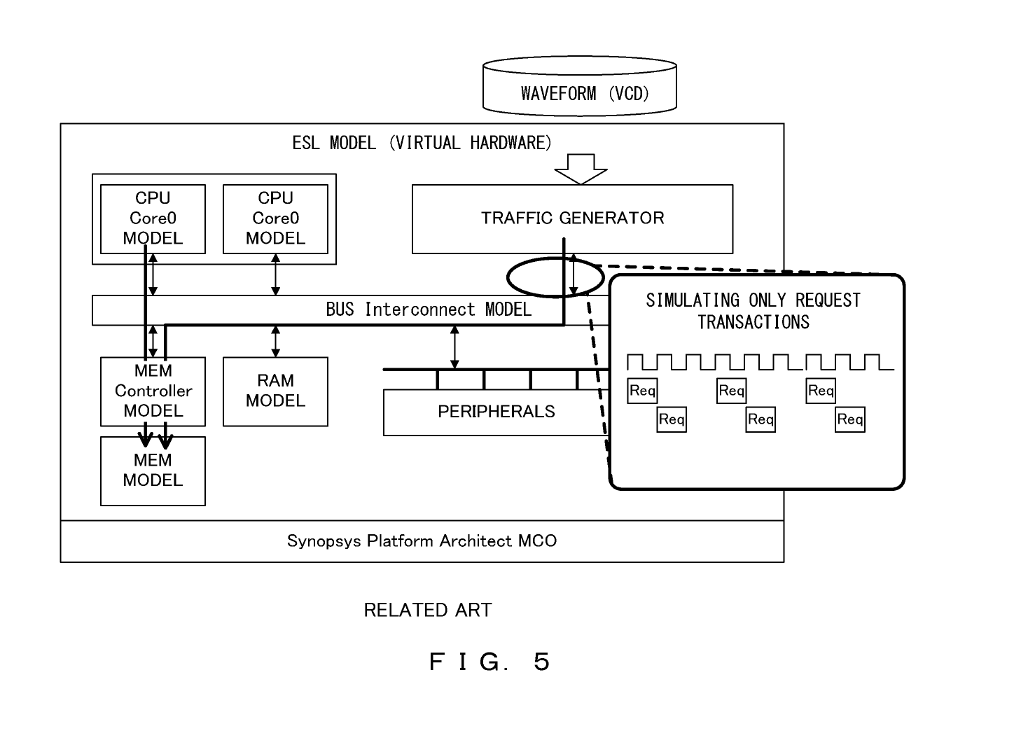

### DESCRIPTION OF EMBODIMENTS

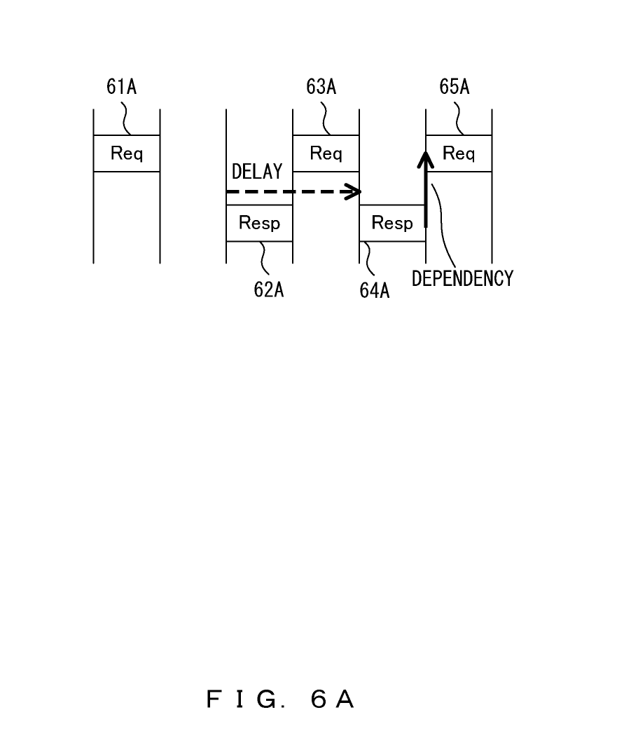

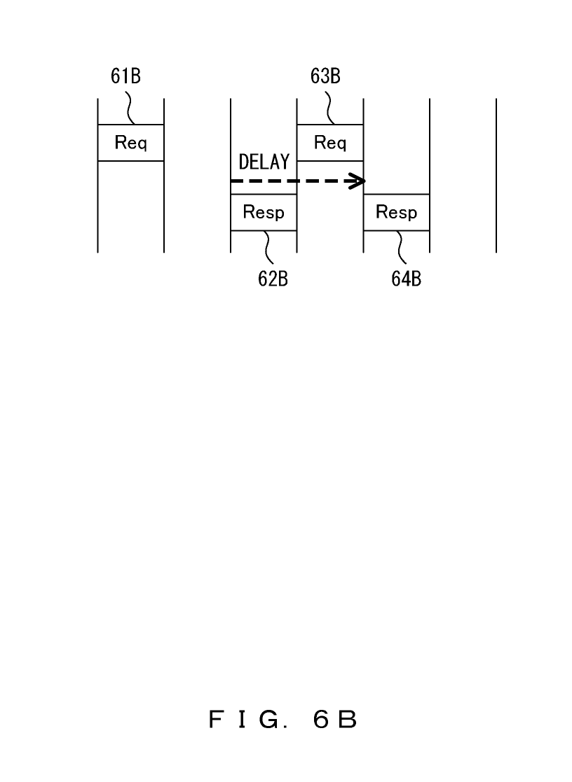

A problem that transactions of a macro fail to be faithfully reproduced is described below with reference to FIGS. 6A and 6B before embodiments are described in detail.

An existing traffic generator is primarily intended to impose a transaction load on a bus and slave devices. Accordingly, the existing traffic generator simulates only a request transaction. As a result, the existing traffic generator does not realize an operation specific to a macro of a certain type.

Specifically, the macro of the certain type waits for a response (referred to also as a response transaction) to a request transaction, and issues the next request transaction after the response is obtained. The exiting traffic generator does not realize an operation having a dependency between transactions as described above. Accordingly, the exiting traffic generator sometimes fails to faithfully reproduce transactions of a macro.

For example, a real operation of hardware can possibly be that illustrated in FIG. 6A. In the case of FIG. 6A, issuance of a first response (response transaction) to a first request (request transaction) 61A is delayed by some cause. In consequence, actually, the first response (response transaction) is issued as indicated by a reference numeral “64A”.

In this case, a second request (request transaction) 63A to be originally issued is issued after the first response 64A is issued. Accordingly, the second request (request transaction) is issued with a delay as indicated by a reference numeral “65A”.

In the meantime, a traffic generator performs a simulation as illustrated in FIG. 6B. In FIG. 6B, issuance of a first response (response transaction) 62B to a first request (request transaction) 61B is delayed by some cause. In consequence, the first response (response transaction) is issued as indicated by a reference numeral “64B”. In FIG. 6B, however, even when the first response 64B is issued with a delay as described above, a second request (request transaction) 63B is issued without waiting for the issuance of the first response 64B, and is not delayed.

An aspect of the embodiments described below aims at providing a technique that enables transactions of a macro to be faithfully reproduced with ease and in a short time. According to the following embodiments, a waveform of a macro and parameters of characteristic operations of the macro are only prepared when RTL is present, thereby enabling transactions of the macro to be faithfully reproduced with ease and in a short time.

The embodiments are described in detail below with reference to the drawings. Points of the embodiment are the following three.

(1) A mechanism for faithfully reproducing transactions of a macro by giving, as parameters, specifications of characteristic operations of the macro (namely, a dependency between operations of transactions) to waveform information of the macro.

(2) A mechanism for describing a dependency between operations of transactions on a transaction scenario.

(3) A mechanism for realizing a dependency between operations of transactions.

This embodiment takes the form of software (namely, a program) executed in a hardware system (such as a personal computer). The software is, specifically, a transaction generating program to be described later (namely, a program for generating transactions for a performance evaluation). Also a transaction generating apparatus as a hardware system (personal computer) that executes the transaction generating program is disclosed.

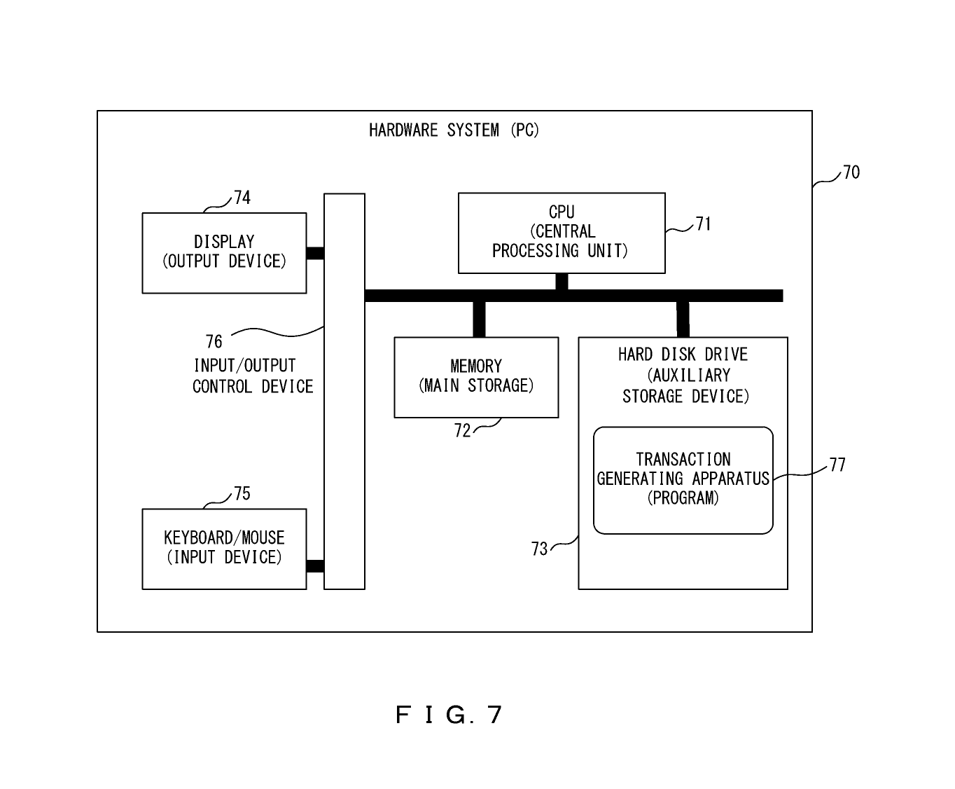

FIG. 7 illustrates the hardware system (specifically, a personal computer) of the transaction generating apparatus that executes the transaction generating program for generating transactions for a performance evaluation.

In FIG. 7, the hardware system (personal computer) 70 is a computer. The hardware system 70 includes a CPU (Central Processing Unit) 71, a memory (namely, a main storage) 72, a hard disk drive 73, a display 74, a keyboard/mouse 75, and an input/output control device (input/output controller) 76. The hard disk drive 73 is one example of an auxiliary storage device. The display 74 is one example of an output device. “keyboard/mouse” means “a keyboard and/or a mouse”. The keyboard/mouse 75 is one example of an input device.

The transaction generating apparatus 77 is realized in a way such that the CPU 71 executes the transaction generating program stored in the hard disk drive (auxiliary storage device) 73.

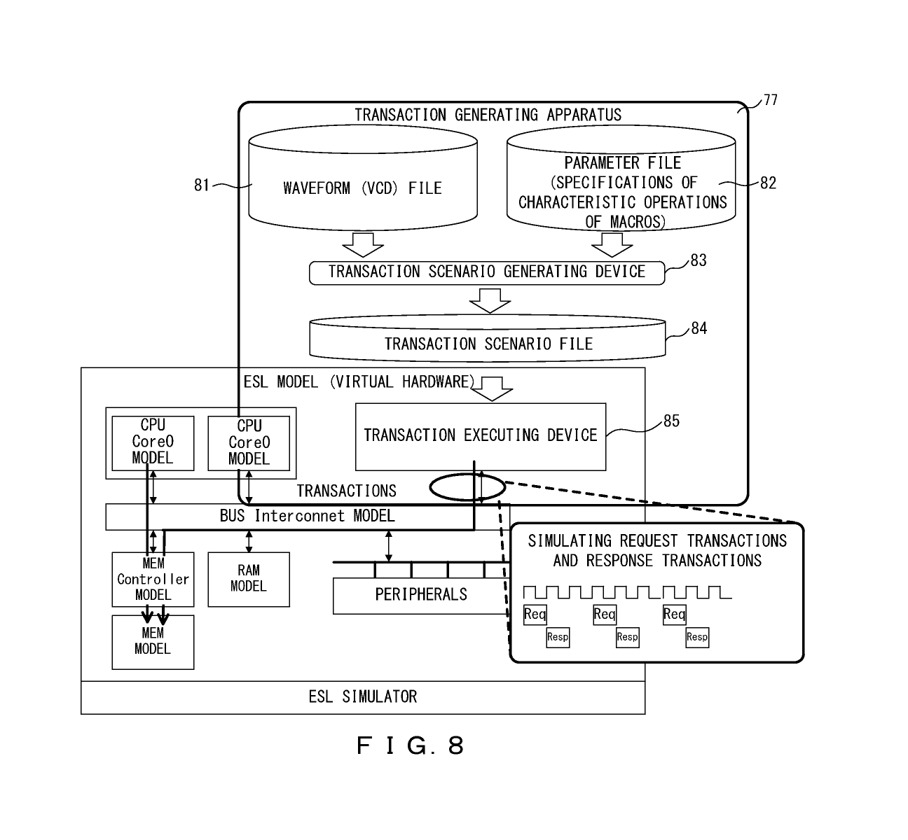

FIG. 8 illustrates a structure of the transaction generating apparatus.

In FIG. 8, the transaction generating apparatus 77 includes a transaction scenario generating device 83 and a transaction executing device 85.

The transaction scenario generating device 83 generates a transaction scenario based on waveform data stored in a waveform (VCD) file 81, and specifications of characteristic operations of macros, which are stored in a parameter file 82. The transaction scenario describes each dependency between operations of semiconductor elements included in a semiconductor circuit. The transaction scenario generating device 83 stores the generated transaction scenario in a transaction scenario file 84.

The waveform (VCD) file 81 stores the waveform data. The waveform data is information that indicates a level transition of each signal output from each of the semiconductor elements included in the semiconductor circuit.

Additionally, the parameter file 82 stores specifications of characteristic operations of macros as parameters for defining each dependency between operations of the semiconductor elements.

The transaction executing device 85 generates transactions for testing an architecture of the semiconductor circuit based on the transaction scenario stored in the transaction scenario file 84.

Then, the transaction generating apparatus 77 is mounted, for example, in the system level test tool “Platform Architect MCO” offered by Synopsys, Inc., thereby enabling an architecture of the semiconductor circuit to be evaluated.

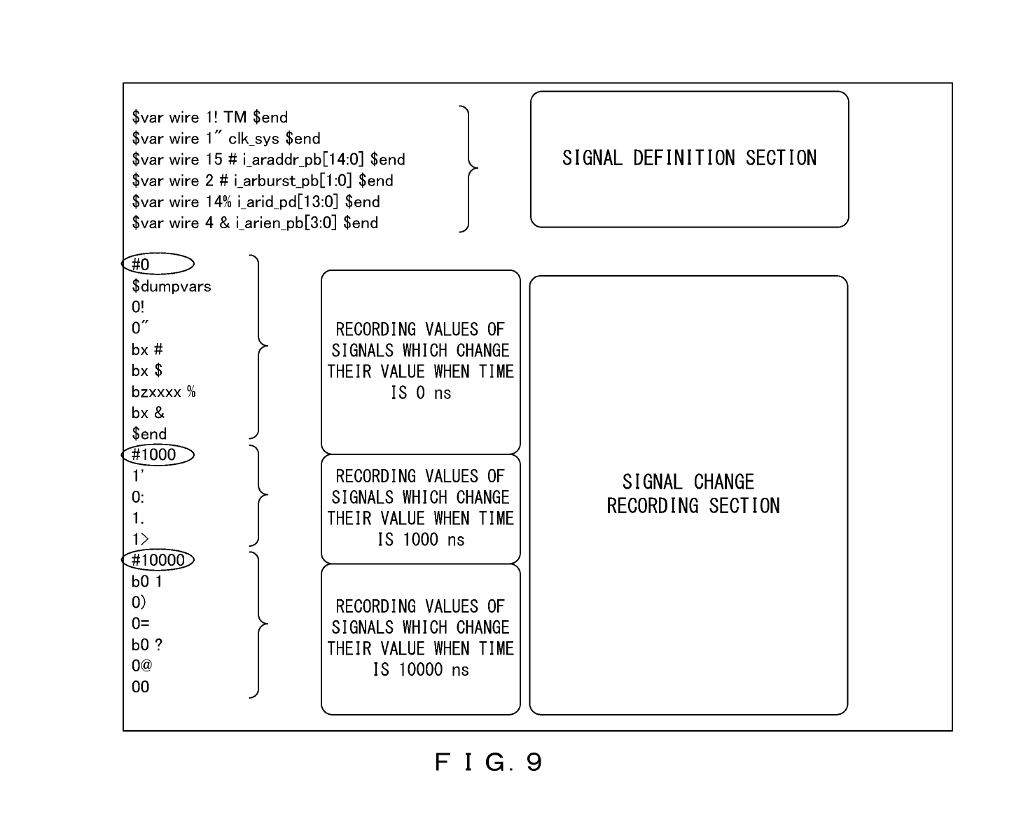

FIG. 9 illustrates an example of the waveform file.

In FIG. 9, the waveform file 81 includes a signal definition section and a signal change recording section. The signal definition section defines signals the behavior of which is to be recorded. The signal change recording section records a time at which a state of a signal changes, and a changed value of the signal. In the example illustrated in FIG. 9, the following values are recorded in the signal change recording section.

values of signals which change when a time is 0 [ns])

values of signals which change their values when the time is 1000 [ns]

values of signals which change their values when the time is 10000 [ns]

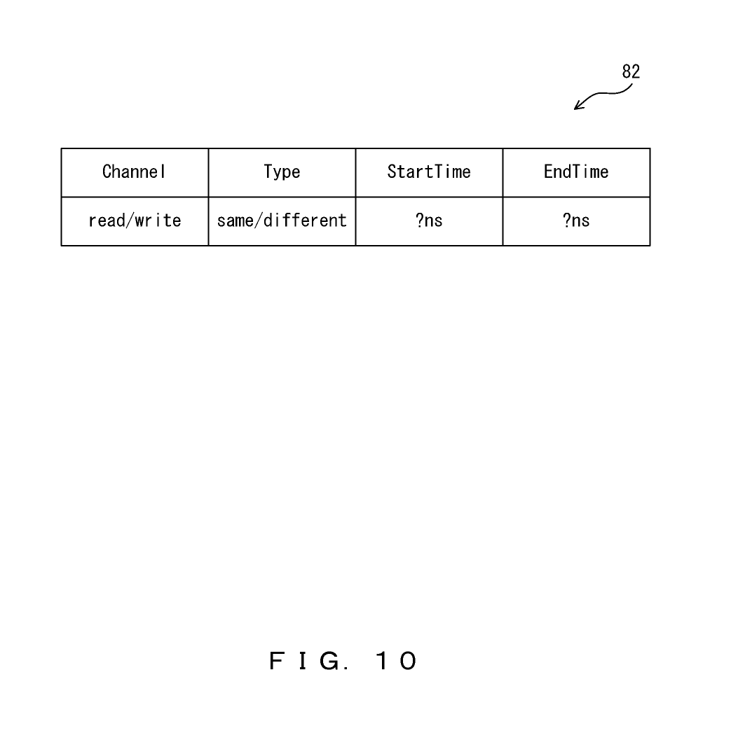

FIG. 10 illustrates an example of the parameter file.

In FIG. 10, the parameter file 82 includes parameters such as “Channel”, “Type”, “StartTime”, and “EndTime”. In the parameter file 82, parameters for putting a transaction dependency are set as specifications of characteristic operations of macros.

“Channel” specifies a target channel on which a dependency is to be put. A channel is a unit of parallel processing of transactions. For example, a value “read” indicates a read channel, whereas a value “write” indicates a write channel.

“Type” is a parameter that indicates whether transactions are processed either within the same channel in parallel or in different channels. With “Type”, a type of a dependency to be put is specified. Namely, dependency types include two types such as a dependency on another transaction within the same channel, and a dependency on a transaction in a different channel. A value “same” indicates that a dependency on another transaction within the same channel is put. In contrast, a value “different” indicates that a dependency on a transaction in a different channel is put.

“StartTime” specifies a start time “ns” at which a dependency starts to be put. “EndTime” specifies an end time [ns] at which the dependency ends to be put.

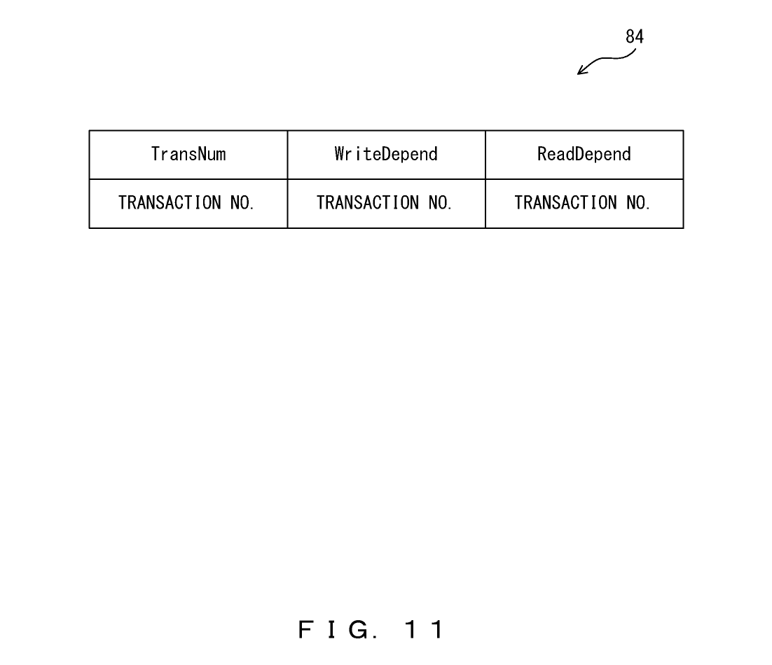

FIG. 11 illustrates an example of the transaction scenario file.

In FIG. 11, the transaction scenario file 84 is a file that represents a sequence of transactions, and each dependency between operations of corresponding transactions. The transaction scenario file 84 includes parameters such as “TransNum”, “WriteDepend”, and “ReadDepend”.

“TransNum” specifies a number of a transaction. “WriteDepend” specifies a transaction number assigned to a write transaction the operation of which depends on the transaction specified by the “TransNum”. “Read Depend” specifies a transaction number assigned to a read transaction the operation of which depends on the transaction specified by “TransNum”.

A set of transactions generated by the transaction generating apparatus 77 is a set of pieces of data generated based on the transaction scenario file 84. Transactions include a request transaction (sometimes referred to as “Req”) and a response transaction (sometimes referred to as “Resp”) to the bus.

As described above, a waveform of a macro only represents transactions of the macro under a certain condition. Accordingly, only reproducing a waveform as in the conventional techniques fails to simulate transactions of a macro in a state other than the condition under which the waveform is obtained.

Accordingly, the transaction generating apparatus 77 externally receives, as inputs, a waveform of a macro, and each dependency between operations of transactions as specifications of characteristic operations of the macro (namely, the waveform and each dependency are externally received in the form of the parameter file). The transaction generating apparatus 77 generates a transaction scenario, on which dependencies are put, based on the parameter values and the waveform information. Then, the transaction generating apparatus 77 executes the transactions based on the transaction scenario generated by the transaction scenario generating device 83 with the use of the transaction executing device 85. In this way, operations of a macro are enabled to be faithfully reproduced also in a state other than a condition under which a waveform is obtained.

The transaction scenario generating device 83 and the transaction executing device 85, which are included in the transaction generating apparatus 77, are respectively described in detail next.

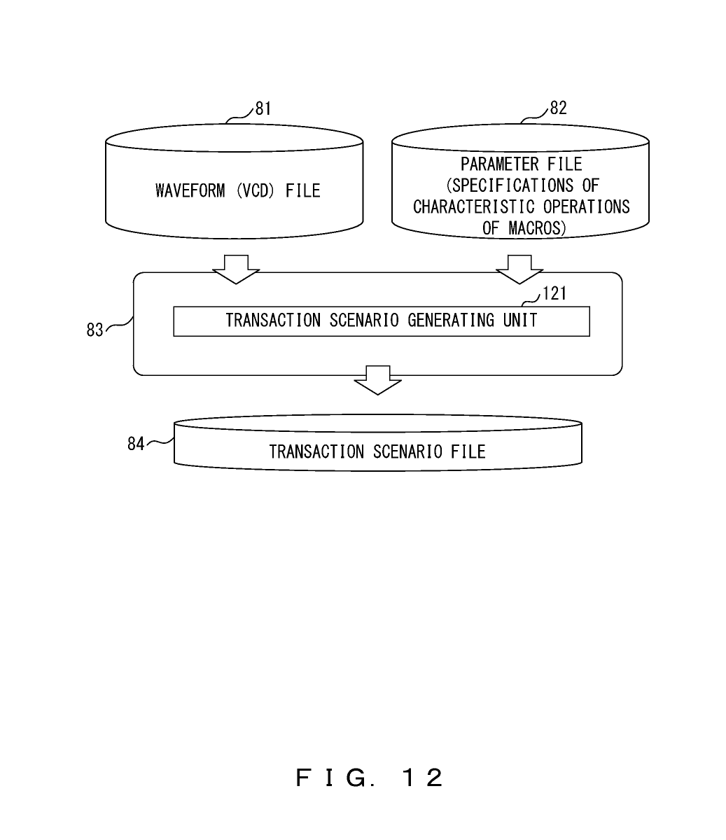

FIG. 12 illustrates a structure of the transaction scenario generating device 83.

As illustrated in FIG. 12, the transaction scenario generating device 83 includes a transaction scenario generating unit 121.

The transaction scenario generating unit 121 generates a transaction scenario based on waveform data stored in the waveform (VCD) file 81, and specifications of characteristic operations of macros, which are stored in the parameter file 82. The transaction scenario describes each dependency between operations of the semiconductor elements included in the semiconductor circuit. The transaction scenario generating unit 121 stores the generated transaction scenario in the transaction scenario file 84.

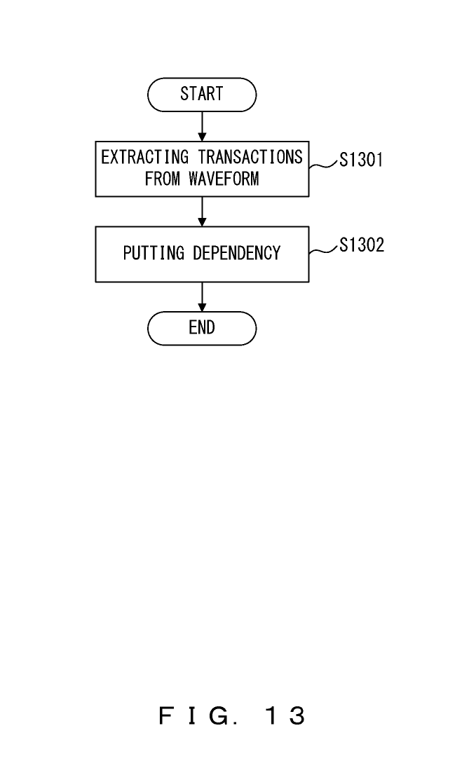

FIG. 13 is a flowchart illustrating a flow of the transaction scenario generating process executed by the transaction scenario generating device 83.

In step S1301, transactions are extracted from a waveform. In step S1302, dependencies are put. These processes will be described in detail later.

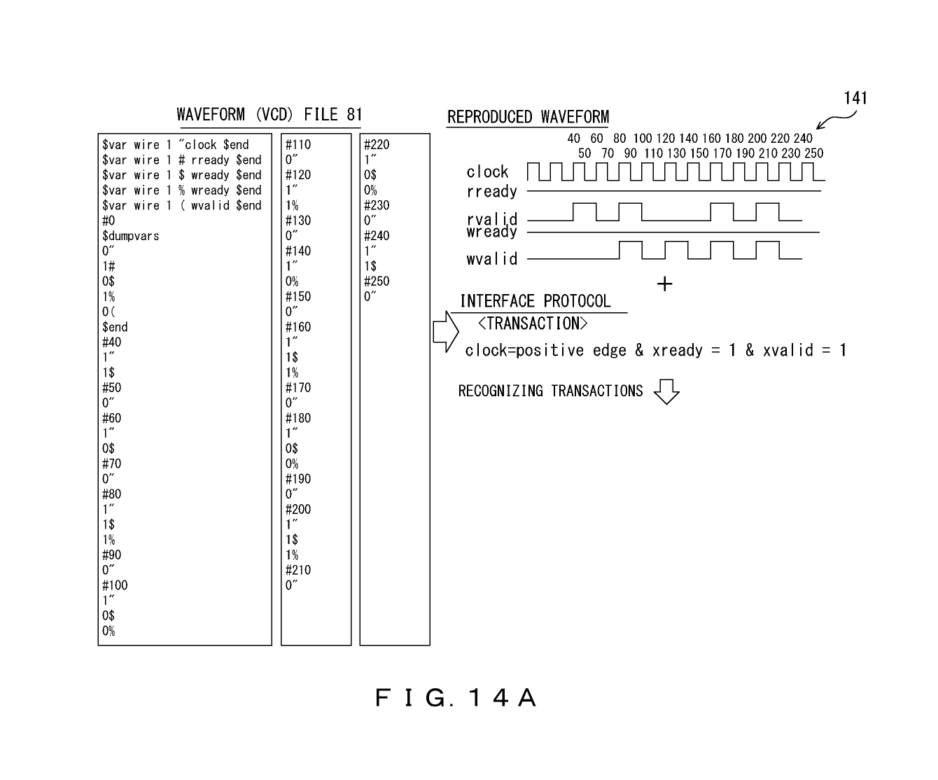

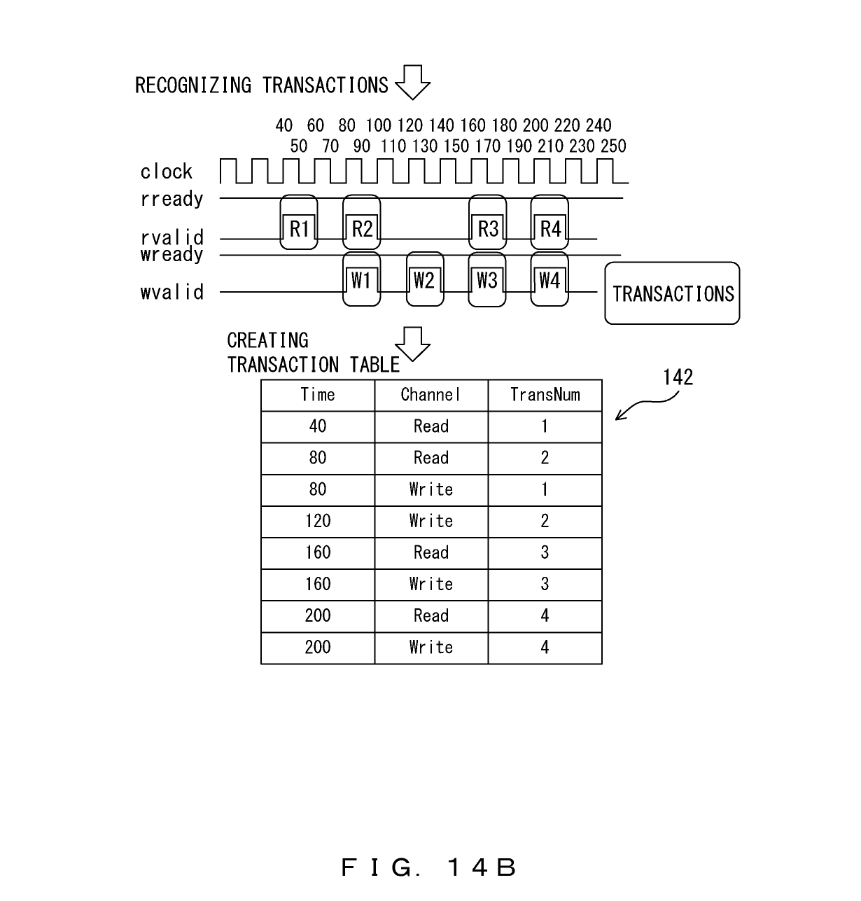

FIGS. 14A and 14B are explanatory diagrams of the process for extracting transactions from the waveform in step S1301 of FIG. 13.

As illustrated in FIGS. 14A and 14B, a state of each signal is internally reproduced (the state of the reproduced signal is illustrated as a reproduced waveform 141) based on a signal value at each time of the waveform (VCD) in the waveform (VCD) file 81. Then, transactions are recognized based on the reproduced waveform and specifications of an interface protocol.

For example, according to the waveform (VCD), an “rready” signal has a value of 1 and an “rvalid” signal has a value of 1 at rising of a “clock” signal when a time is 40 [ns] Accordingly, transactions are recognized based on specifications of the interface protocol.

An internal signal name of the “clock” signal is a double quotation (“), an internal signal name of the “rready” signal is a sharp sign (#), and an internal signal name of the “rvalid” signal is a dollar sign “$”. For a case of the time 40 [ns], see a section having a header “#40”. In this section, the “clock” signal is set to 1. Moreover, the “rready” signal is set to 1 when the time is 0 [ns]. Accordingly, as described above, the “rready” signal has a value of 1 and the “rvalid” signal has a value of 1 at the rising of the “clock” signal when the time is 40 [ns].

Thereafter, numbers are sequentially assigned to transactions in the order where they are recognized. Each of the assigned numbers is stored in a “TransNum” field. Moreover, each time when a transaction is established is stored in a “Time” field. Then, the value “Read” or “Write” is stored in a “Channel” field. The transaction table 142 is created in this way.

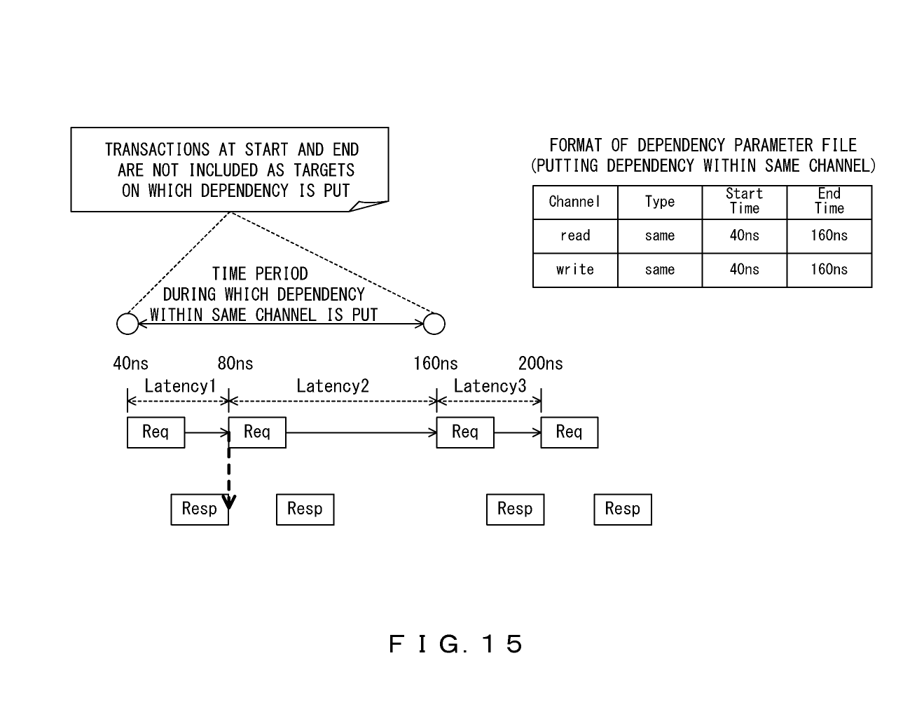

FIG. 15 is an explanatory diagram of a case where a dependency within the same channel is put in the process for putting a dependency in step 1302 of FIG. 13.

When the value “same” is set as the “Type” parameter, a dependency is put on each transaction present between time points specified by “StartTime” and “EndTime” parameters within a channel (channel represented by “read” or “write”) specified by the “Channel” parameter. Namely, if a transaction issued immediately before a request, which occurs in a time period excluding a start and an end of a focused channel, is present within the focused channel between the time points specified by the parameter file 80, a dependency that signifies waiting for a response transaction is put on the transaction.

For example, in the following case, a dependency of an operation is put between transactions present between 40 [ns] and 160 [ns] within the read channel.

Type=Same

Channel=read

StartTime=40 [ns]

EndTime=160 [ns]

Additionally, in the following case, a dependency of an operation is put between transactions present between 40 [ns] and 160 [ns] within the write channel.

Type=Same

Channel=write

StartTime=40 [ns]

EndTime=160 [ns]

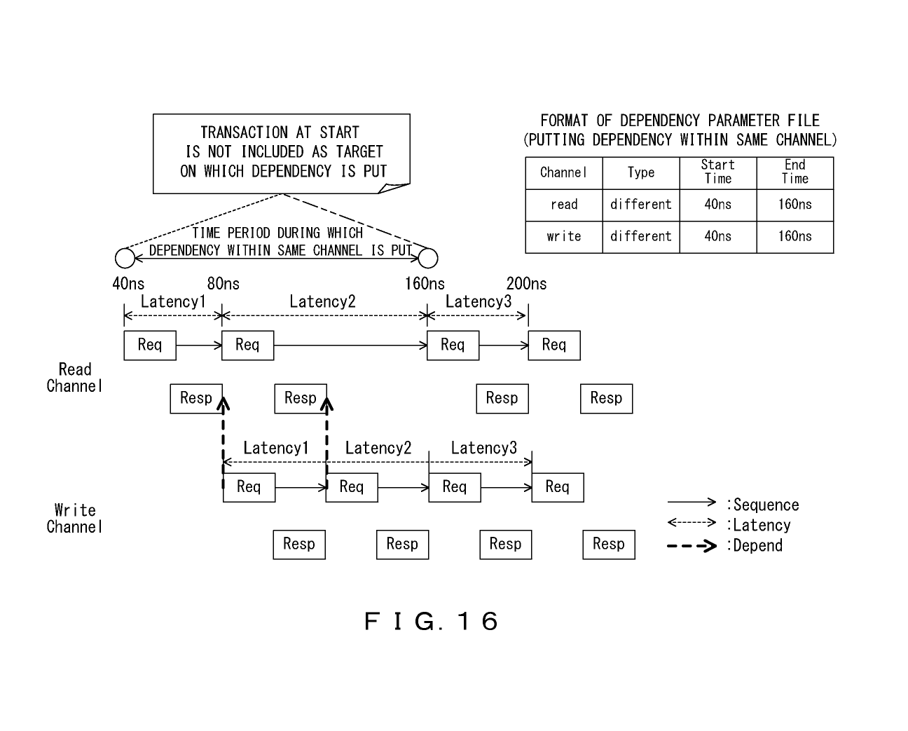

FIG. 16 is an explanatory diagram of a case where a dependency between different channels is put in the process for putting a dependency in step 1302 of FIG. 13.

When the value “different” is set as the “Type” parameter, a dependency of an operation is put on each transaction present between the time points specified by the “StartTime” parameter and the “EndTime” parameter in the channel specified by the “Channel” parameter (the channel represented by the “read” or “write”) and the other channel (namely, the write channel when the value “read” is specified as the “Channel” parameter or the read channel when the value “write” is specified as the “Channel” parameter). Namely, if a transaction issued immediately before a request, which occurs in a time period between the start and the end of a focused channel, is present in a different channel within the time frame specified by the parameter file 82, a dependency of the operation that means waiting for a response transaction is put.

For example, in the following case, a dependency of the operation is put by the read channel on a transaction present between 40 [ns] and 160 [ns] in the write channel.

Type=different

Channel=read

StartTime=40 [ns]

EndTime=160 [ns]

Additionally, in the following case, a dependency of the operation is put by the write channel on a transaction present between 40 [ns] and 160 [ns] in the read channel.

Type=different

Channel=write

StartTime=40 [ns]

EndTime=160 [ns]

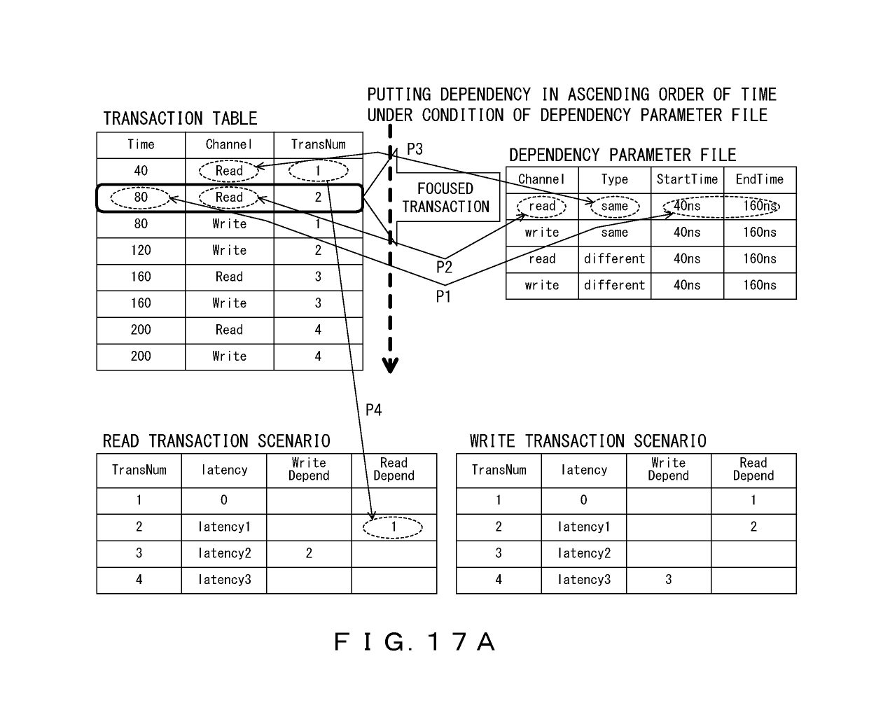

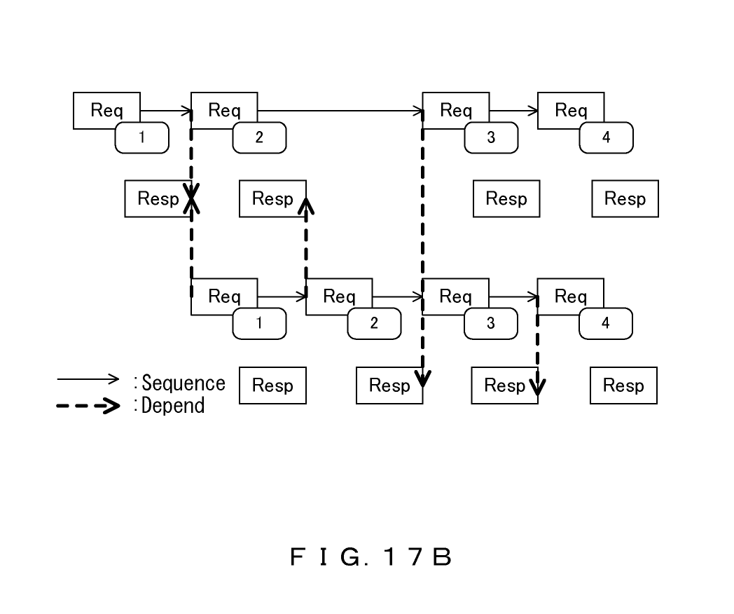

FIGS. 17A and 17B are explanatory diagrams of generation of a transaction scenario. The transaction scenario is generated with the following processes P1 to P4.

In the process P1, a comparison is made between “Time” in the transaction table and each of “StartTime” and “EndTime” in the dependency parameter file. As a result of this comparison, whether or not a focused transaction is a target on which a dependency of an operation may be put is determined.

Assume that the value of “Time” is 80 [ns] as depicted in the transaction table illustrated in FIG. 17A. In this case, the value of “Time” is a value between the value of “StartTime” 40 [ns] and the value of “EndTime” 160 [ns] as depicted in the “dependency parameter file” illustrated in FIG. 17A. Accordingly, the focused transaction is determined to be the target to which the dependency may be put, and a control proceeds to the process P2. Alternatively, when the value of “Time” is not a value between “StartTime” and “EndTime”, such as 200 [ns], the next row in the transaction table is focused, and a process similar to the above described one is executed.

In the process P2, “Channel” in the transaction table, and “Type” in the dependency parameter file are referenced. Then, a scheme for putting a dependency is determined.

For example, when the same value as “Channel” in the transaction table is set as “Channel” (taking the value of “read” or “write”) in the dependency parameter file and the corresponding value of “Type” is “same” as illustrated in FIG. 17A, putting a dependency in the same channel is selected, and the control next proceeds to the process P3. Alternatively, when the same value as “Channel” in the transaction table is set as “Channel” (taking the value of “read” or “write”) in the dependency parameter file and the corresponding value of “Type” is “different”, putting a dependency in different channels is selected, and the control next proceeds to the process P3.

In the process P3, a comparison is made between “Channel” of a transaction at an immediately preceding time and

“Channel” in the focused transaction based on the scheme selected for putting a dependency. With this comparison, whether or not to put a dependency is determined. If a transaction is not present at the immediately preceding time, the control returns to the process P1 after the focused transaction is changed to the next time.

For example, when the following two conditions hold true, a dependency is put (see FIG. 17B). Then, the control proceeds to the process P4.

Putting a dependency in the same channel is selected

“Channel” of the transaction at the immediately preceding time and “Channel” of the focused transaction are the same.

In contrast, when the following two conditions hold true, the control proceeds to the process P2.

Putting a dependency in the same channel is selected.

“Channel” of the transaction at the immediately preceding time and “Channel” of the focused transaction are different.

Also when the following two conditions hold true, the control proceeds to the process P2.

Putting a dependency between different channels is selected.

“Channel” of the transaction at the immediately preceding time and “Channel” of the focused transaction are the same.

In contrast, when the following two conditions hold true, a dependency is put (see FIG. 17B). And, the control next proceeds to the process P4.

Putting a dependency between different channels is selected.

“Channel” of the transaction at the immediately preceding time and “Channel” of the focused transaction are different.

In the process P4, the value of “TransNum” of the transaction on which the focused transaction depends is written to a row corresponding to the focused transaction in a transaction scenario corresponding to the value of “Channel” in the focused transaction. Then, a transaction at the next time is focused next, and the control returns to the process P1.

As described above, a dependency between operations of transactions is described on a transaction scenario. This enables transactions of a macro to be faithfully reproduced also inclusive of each dependency between operations of transactions (namely, inclusive of each dependency that the conventional techniques fail to take into account) when waveform information is used.

Additionally, the scheme for automatically generating a transaction scenario based on waveform and parameters is realized. This scheme is used along with the transaction executing device 85, thereby enabling cost needed to develop models to be reduced, and also enabling models to be developed with ease and in a short time.

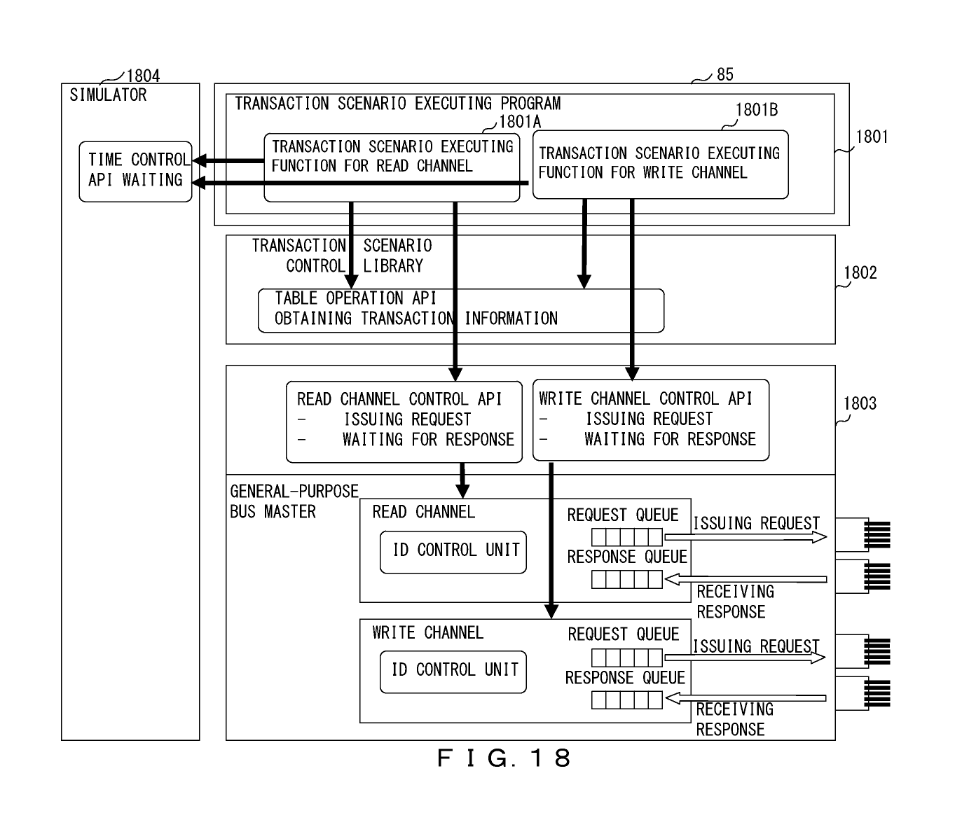

FIG. 18 is an explanatory diagram of how the transaction executing program, with which the transaction executing device 85 executes a transaction executing process, works.

The transaction executing program 1801 is a software program with which the transaction executing device 85 executes the transaction executing process. The transaction executing device 85 executes the transaction scenario created as described above according to the transaction executing program 1801.

Additionally, the transaction executing program 1801 for executing a transaction scenario includes a transaction scenario executing function 1801A for a read channel and a transaction scenario executing function 1801B for a write channel, which are functions of a programming language.

The transaction scenario executing function 1801A for the read channel or the transaction scenario executing function 1801B for the write channel obtains transaction information (namely, the above described transaction scenario) stored in a transaction scenario control library 1802 via a table operation API (Application Programming Interface).

Additionally, the transaction scenario executing function 1801A for the read channel and the transaction scenario executing function 1801B for the write channel execute processes such as an adjustment of an issuance interval of requests (namely, an adjustment of a latency), and the like for the simulator 1804 such as an ESL simulator or the like via the time control API.

Additionally, the transaction scenario executing function 1801A for the read channel executes processes such as issuance of a request, waiting for a response, and the like for the read channel of a general-purpose bus master 1803 via the read channel control API. The transaction scenario executing function 1801B for the write channel executes processes such as issuance of a request, waiting for a response, and the like for the write channel of the general-purpose bus master 1803 via the write channel control API.

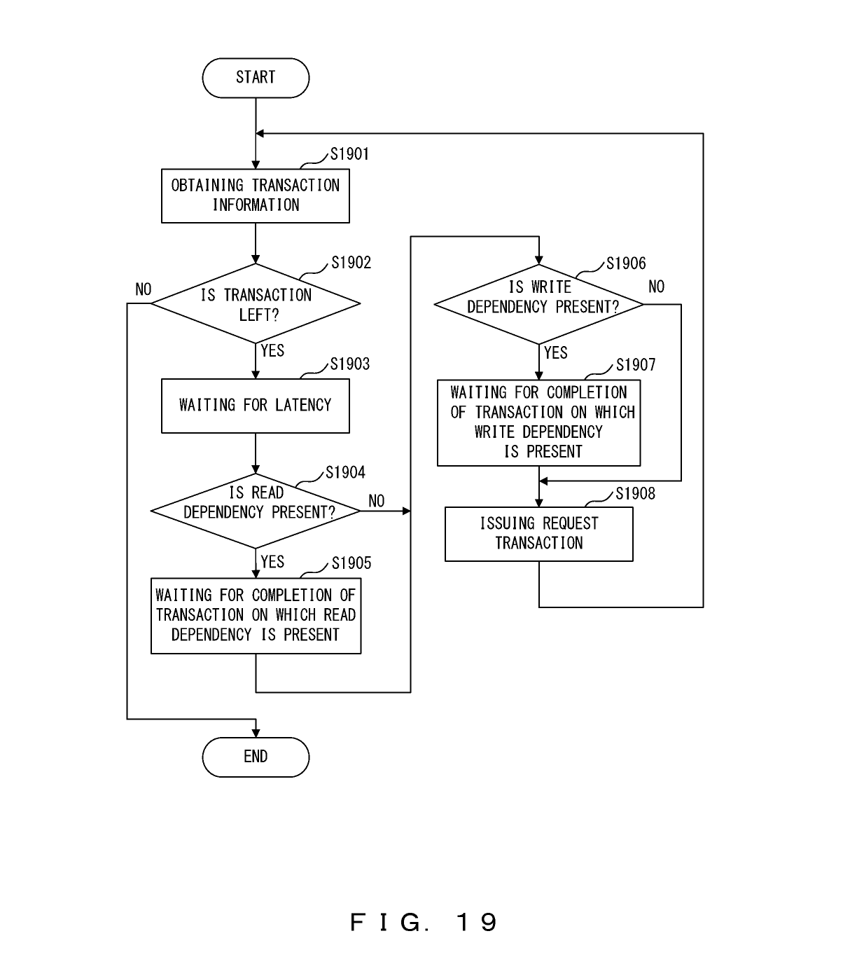

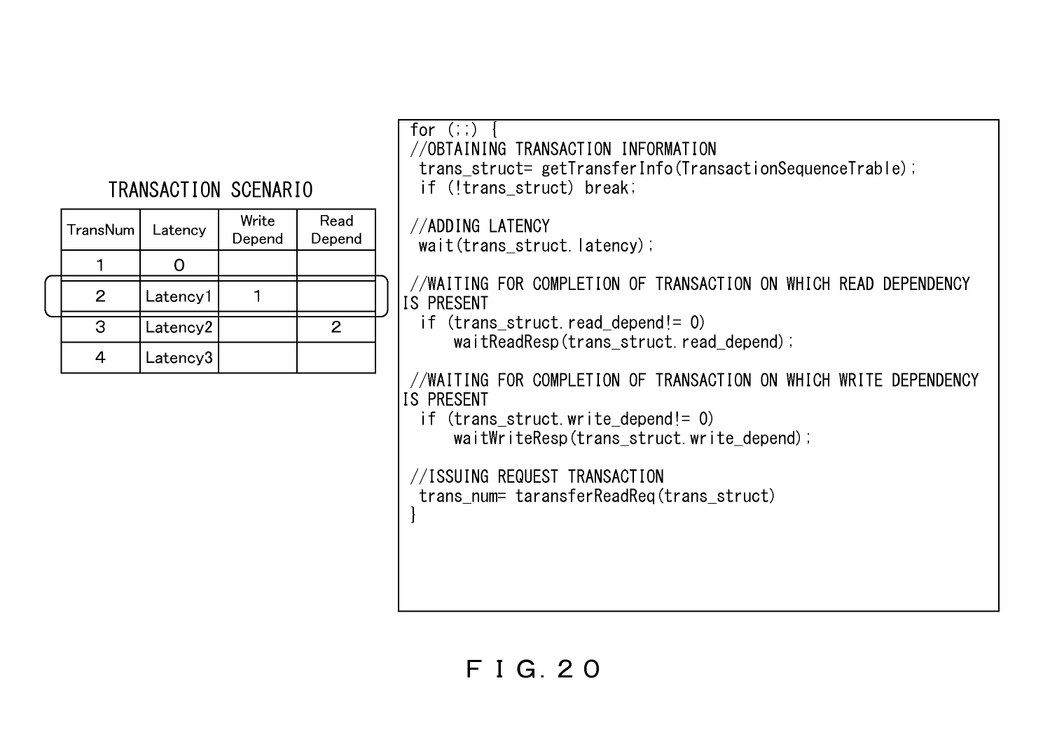

FIG. 19 is a flowchart illustrating a flow of the transaction executing process executed by the transaction executing device 85. FIG. 20 illustrates an example of the transaction executing program.

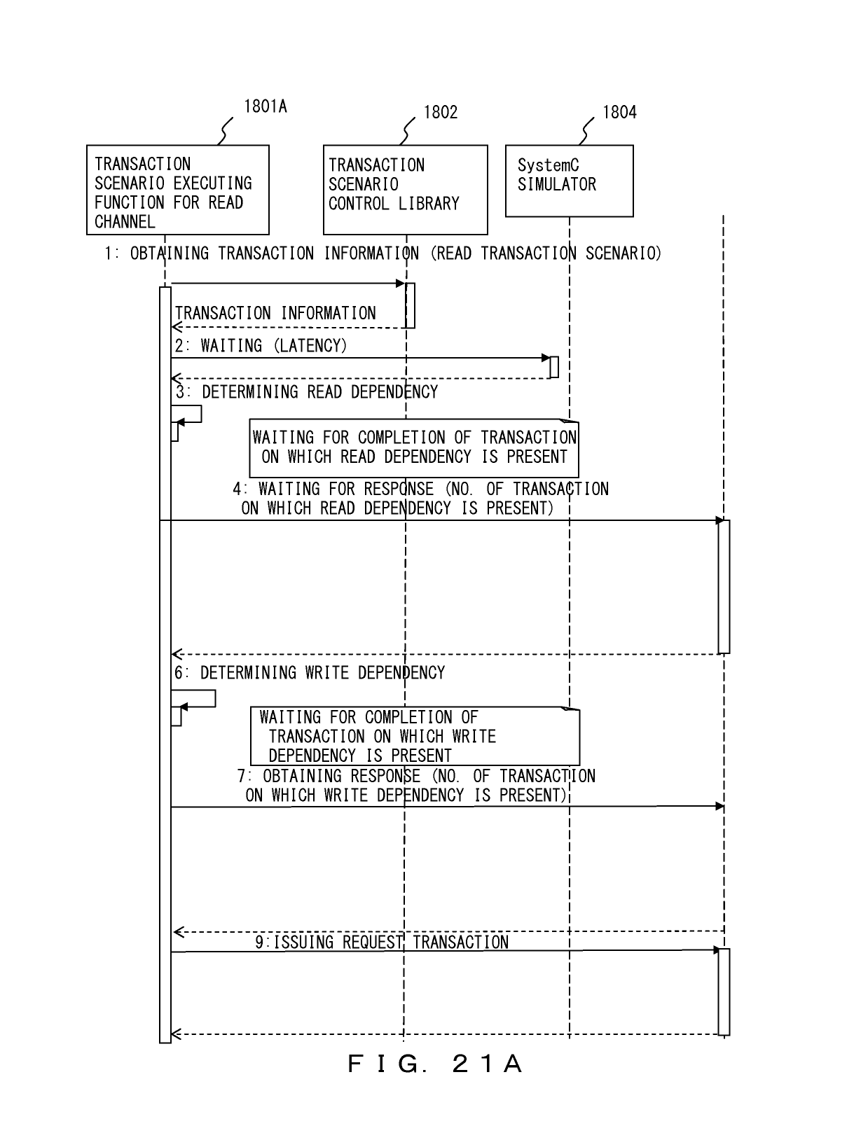

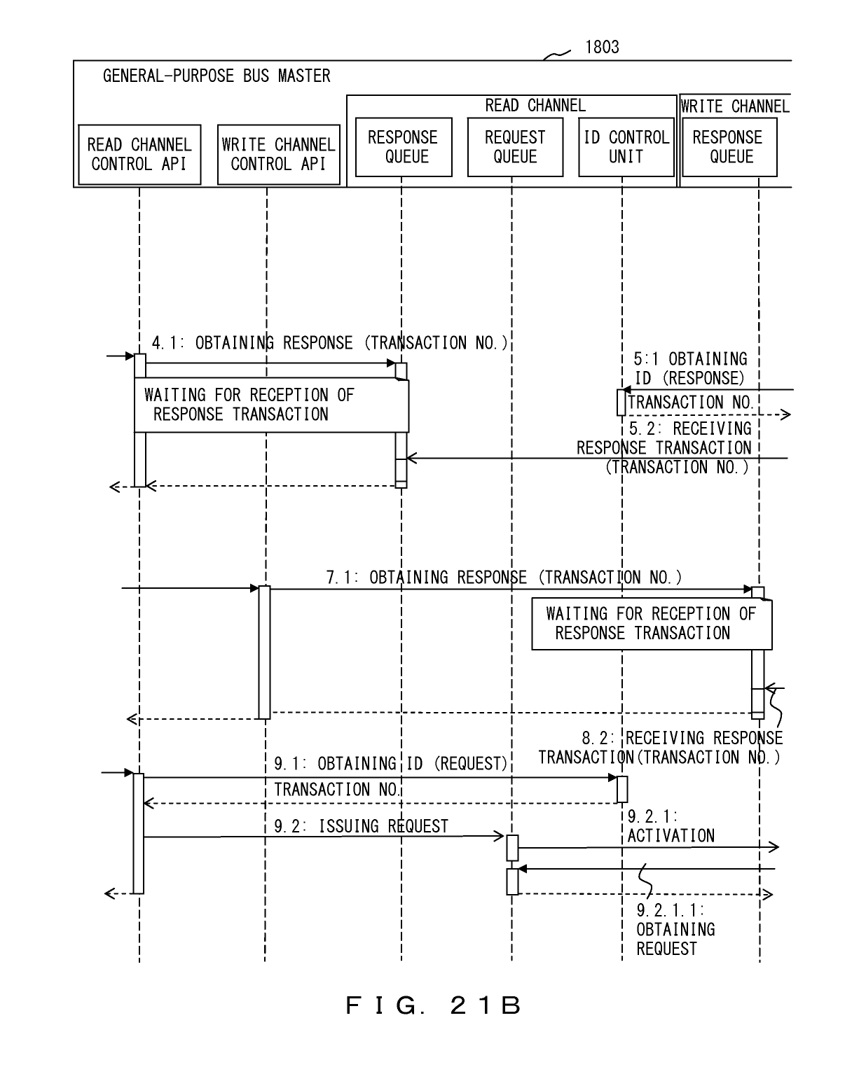

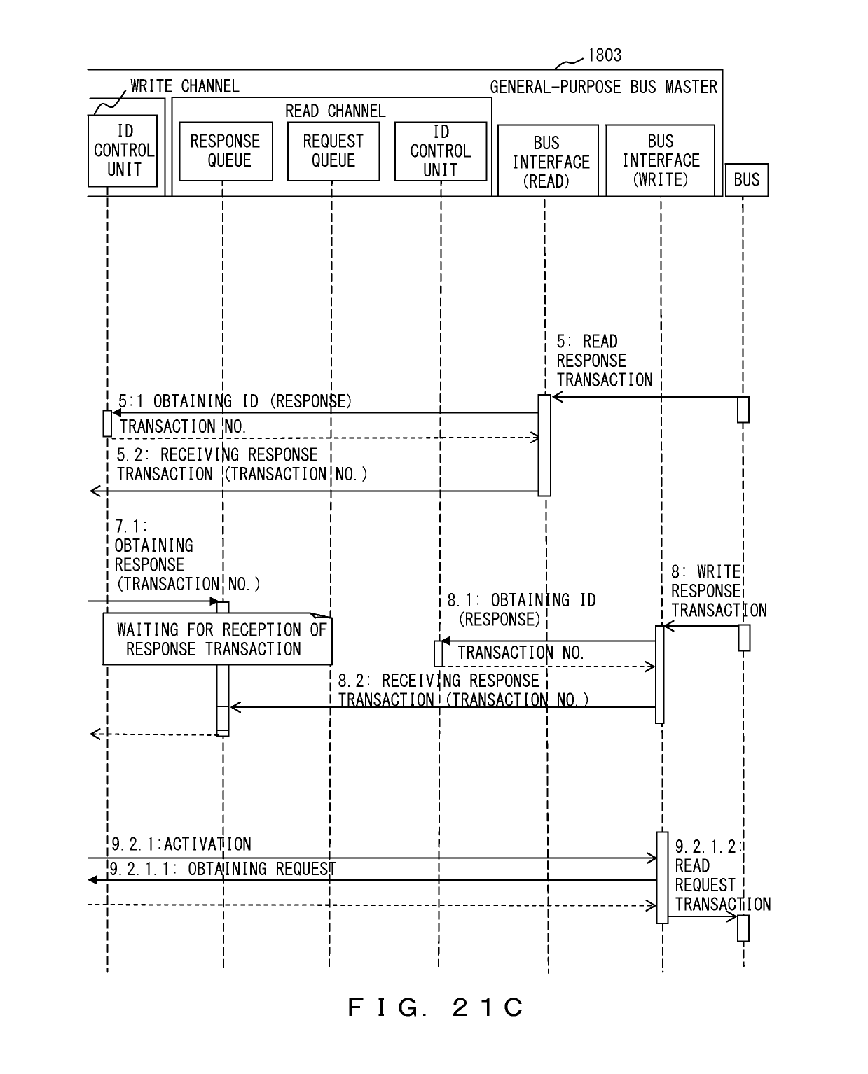

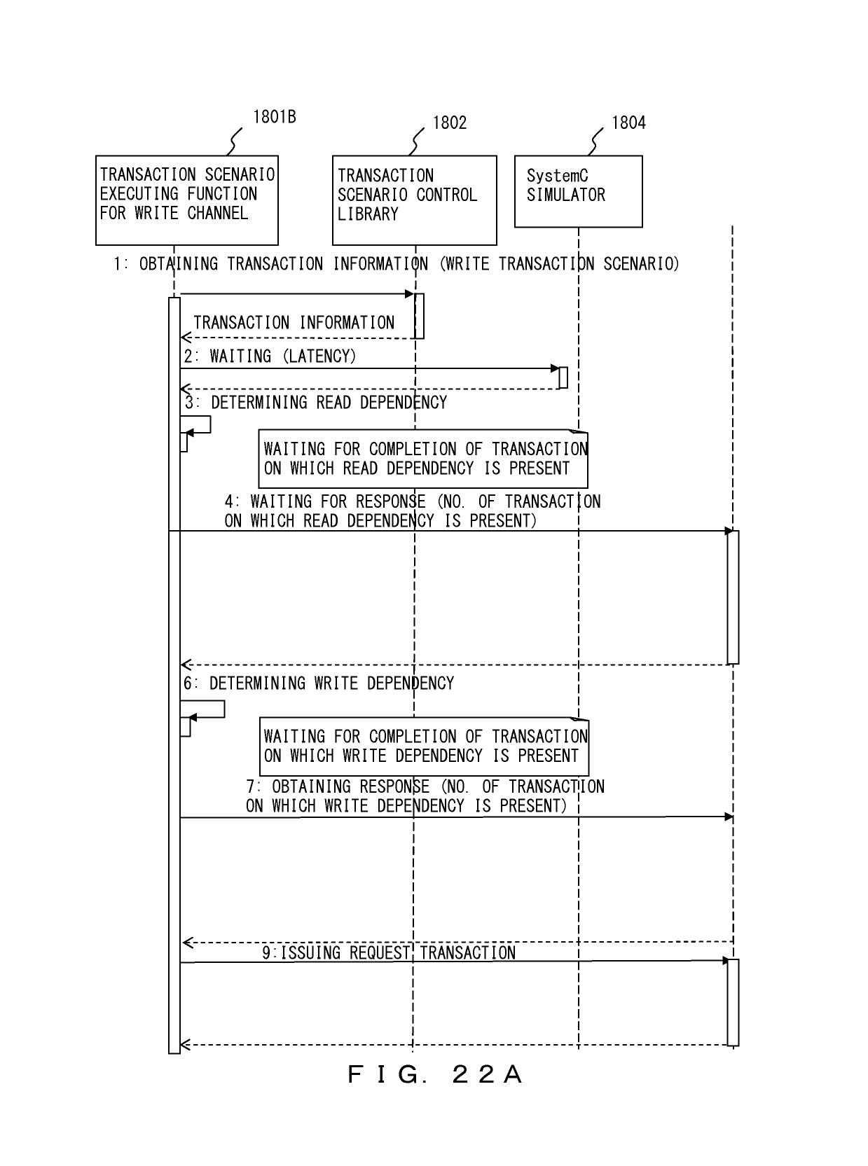

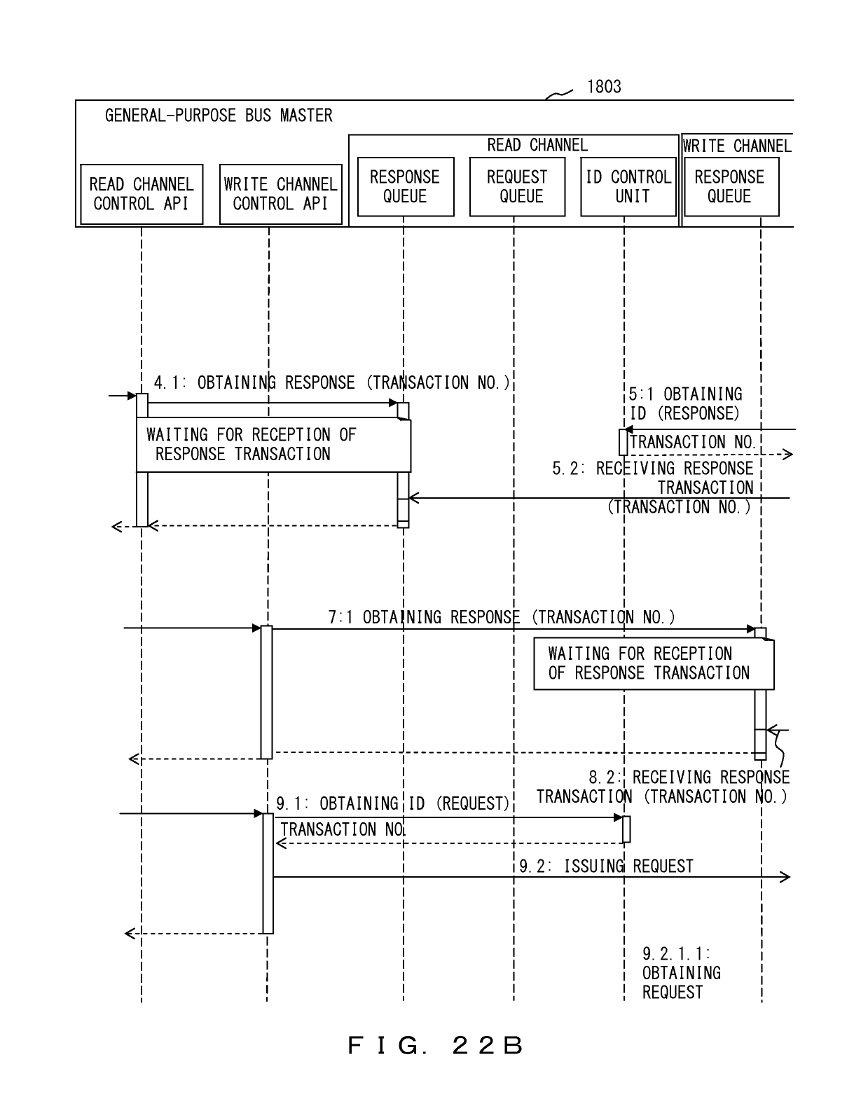

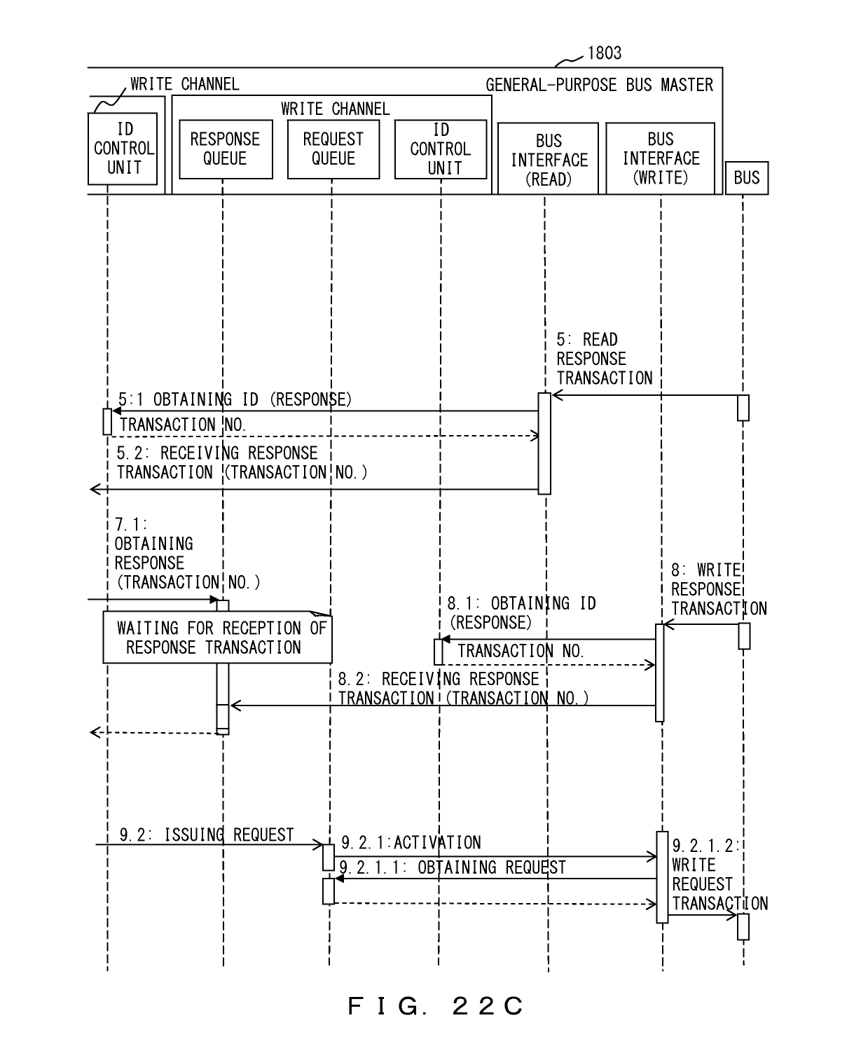

FIGS. 21A to 21C illustrate a flow of an operation (specifically, a flow of a read operation) of the transaction executing device 85 that executes the transaction executing process. FIGS. 22A to 22C illustrate a flow of an operation (specifically, a flow of a write operation) of the transaction executing device 85 that executes the transaction executing process.

The transaction executing process executed by the transaction executing device 85 realizes a dependency of an operation between transactions. Specifically, completion of a specified transaction is waited before a request is issued based on dependency information defined in a transaction scenario, whereby the dependency of the operation is realized between the transactions. This waiting is realized in a way such that the general-purpose bus master 1803 uses the read channel control API and the write channel control API, which are made public.

Namely, at first, the transaction executing device 85 sequentially obtains entries of the transaction scenario generated by the transaction scenario generating device 83 from the transaction scenario control library 1802 in step S1901 of FIG. 19.

Then, in step S1902, the transaction executing device 85 determines whether or not the entries of the transaction scenario have been obtained in step S1901. Namely, the transaction executing device 85 determines whether or not all the entries of the transaction scenario stored in the transaction scenario control library 1802 have been obtained.

If the transaction executing device 85 determines that an entry yet to be obtained of the transaction scenario is not left as a result of sequentially obtaining the entries of the transaction scenario stored in the transaction scenario control library 1802 (“NO” in step S1902), the transaction executing device 85 terminates this transaction executing process. Alternatively, if the transaction executing device 85 determines that an entry of the transaction scenario is obtained (“YES” in step S1902), waiting is made in step S1903 (namely, waiting is made for a time set as a latency).

Next, in step S1904, the transaction executing device 85 determines whether or not a read dependency is present in the entries of the transaction scenario obtained in step S1901.

If the transaction executing device 85 determines that the read dependency is not present (“NO” in step S1904), the flow proceeds to step S1906. Alternatively, if the transaction executing device 85 determines that the read dependency is present (“YES” in step S1904), completion of a transaction on which the read dependency is present is waited in step S1905.

Next, in step S1906, the transaction executing device 85 determines whether or not a write dependency is present in the entries of the transaction scenario obtained in step S1901.

If the transaction executing device 85 determines that the write dependency is not present (“NO” in step S1906), the flow proceeds to step S1908. Alternatively, if the transaction executing device 85 determines that the write dependency is present (“YES” in step S1906), completion of a transaction on which the write dependency is present is waited in step S1908.

Then, in step S1908, a request transaction is issued. Thereafter, the transaction executing process returns to step S1901.

The above described series of processes is repeated until no more transaction information is obtained (namely, until entries yet to be obtained of the transaction scenario are not left within the transaction scenario control library 1802).

The transaction executing device 85 executes the transaction executing process as described above, where by the read operation illustrated in FIGS. 21A to 21C is performed, and the write operation illustrated in FIGS. 22A to 22C is performed. The operations illustrated in FIGS. 21A to 21C and 22A to 22C are repeatedly performed until all generated transactions have been executed.

By using the above described transaction executing device 85, a workload of model development is reduced. Namely, a series of steps such as a specification design, coding and a test of a model are not needed, making it sufficient to create a transaction scenario based on a result of examining transaction specifications of a macro. This enables transactions of a macro to be faithfully reproduced with ease and in a short time.

The embodiments have been described above. The above described transaction generating apparatus 77 for generating transactions for a performance evaluation is able to classify transactions into a request transaction and a response transaction, and to control them. Moreover, the transaction generating apparatus 77 enables a dependency of an operation to be put between a request transaction and a response transaction by using a function of waiting for the response transaction to a specified transaction.

Additionally, a dependency is enabled to be represented, thereby making it possible to faithfully reproduce transactions of a macro. The conventional techniques failed to faithfully reproduce transactions of a macro. Specifically, the above described embodiments make it possible to faithfully reproduce a phenomenon that timing for issuing a request transaction changes when an operational condition varies.

Furthermore, only creating a transaction scenario enables transactions of a macro to be faithfully reproduced. This enables reductions in cost of model development, and also enables models to be developed with ease and in a short time.

The above described transaction generating apparatus for generating transactions for a performance evaluation can be realized by using a normal information processing device (computer). Namely, the transaction generating apparatus 77 may include a CPU, a memory such as a RAM, a ROM and the like, an input device, an output device, an external recording device, a medium driving device, and a network connecting device, which are interconnected by a bus.

The memory stores a program and data, which are used by the transaction generating apparatus 77. The CPU executes the above described transaction scenario generating process and transaction executing process by executing the program with the use of the memory.

The input device is, for example, a keyboard, a pointing device or the like, and used to input an instruction and information from a user. The output device is, for example, a display device, a printer, a speaker or the like, and used to output an inquiry and a process result to a user.

The external recording device is, for example, a magnetic disk device, an optical disk device, a magneto-optical disk device, a tape device or the like. The external recording device also includes a hard disk drive. The transaction generating apparatus 77 stores a program and data in the external recording device, and is able to load them into the memory and use them.

The medium driving device drives a portable recording medium, and accesses its recorded contents. Examples of the portable recording medium include a memory device, a flexible disk, an optical disk, a magneto-optical disk and the like. Examples of the portable recording medium include a CD-ROM (Compact Disk Read Only Memory), a DVD (Digital Versatile Disk), a USB (General-purpose Serial Bus) memory, and the like. A user stores a program and data onto the portable recording medium and is able to load them into the memory and use them.

A computer-readable recording medium for storing a program and data, which are used for the transaction scenario generating process and the transaction executing process in this way, include various types of physical (namely, non-transitory) recording media, such as a memory, an external recording device, and a portable recording medium.

The network connecting device is a communication interface that is connected to a wired or wireless communication network such as a LAN (Local Area Network) or the like and performs a data conversion involved in a communication. The transaction generating apparatus 77 receives a program and data from an external device via the network connecting device, and is able to load them into the memory and use them.

The program and the data, which are stored, for example, in the external recording device, are loaded into the memory of the transaction generating apparatus 77. Moreover, the external device connectable via the network connecting device is able to generate a propagation signal for propagating the program and the data, and to transmit the generated propagation signal to the transaction generating apparatus 77 via an arbitrary transmission medium in the communication network.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a program for causing a computer to execute a process comprising:
generating a transaction scenario that describes a dependency between operations of semiconductor elements included in a semiconductor circuit, according to a parameter for defining the dependency and waveform data that indicates a level transition of each signal output from each of the semiconductor elements; and
generating transactions for testing the semiconductor circuit, according to the transaction scenario.

2. The recording medium according to claim 1, the process further comprising:
executing the transactions.

3. The recording medium according to claim 1, wherein:
the semiconductor circuit includes a first semiconductor element and a second semiconductor element; and
the dependency is a relationship where a transaction of the first semiconductor element depends on a result of a transaction of the second semiconductor element.

4. The recording medium according to claim 1, wherein
the dependency is a relationship between operations performed in a same channel, the same channel being a unit of parallel processing for two or more transactions.

5. The recording medium according to claim 1, wherein
the dependency is a relationship between operations in different channels, each of the different channels being a unit of parallel processing for two or more transactions.

6. A generation apparatus, comprising
a processor that generates a transaction scenario describing a dependency based on waveform data indicating a level transition of each signal output from each of semiconductor elements included in a semiconductor circuit, and a parameter for defining a dependency between operations of the semiconductor elements, and generates transactions for testing the semiconductor circuit based on the transaction scenario.
